(19) United States
(12) Patent Application Publication
(10) Pub. No.: US 2008/0302390 A1
(43) Pub. Date: Dec. 11, 2008

(54) Cleaning a Mask Substrate

(75) Inventor: Abbas Rastegar, Schenectady, NY (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., 5621 BA Eindhoven (NL)

(21) Appl. No.: 11/628,125

(22) PCT Filed: May 18, 2005
(86) PCT No.: PCT/IB05/51619

§ 371 Date: Apr. 10, 2008

Related U.S. Application Data
(60) Provisional application No. 60/575,177, filed on May 28, 2004.

(51) Int. Cl. B08B 3/02

(52) U.S. Cl. 134/10; 134/104.4; 134/99.1; 134/93; 134/61

(57) ABSTRACT

This invention relates to a mask cleaning apparatus 101 and a method of cleaning a mask substrate 110. An embodiment according to the invention is a mask cleaning apparatus 101 with a trap comprising a cold trap 120. An additional heater 130 performs the heating function. The mask cleaning apparatus 101 further comprises a support means 105, an aerosol nozzle 150 for blowing aerosol 155 towards the mask substrate 110. In a first stage of the cleaning process the mask substrate 110 is close to the heater 130, and the mask substrate 110 is heated. In a second stage of the cleaning process, the gas flow 170 is stopped, and the mask 110 is transported close to the cold trap 120. The cold trap 120 is cooled. In a third stage of the cleaning process, the aerosol nozzle 150 blows aerosol 155 towards the mask substrate 110, which detaches particles from the mask substrate 110. This embodiment uses thermophoretic forces for trapping detached particles. Other embodiments according to the invention use vacuum, electrostatic forces and/or getter metal for trapping detached particles.

The invention relates to an apparatus for cleaning a mask substrate comprising:

a support means for receiving a mask substrate; and

an aerosol nozzle for cleaning the mask substrate by detaching particles from the mask substrate.

The invention further relates to a method of cleaning a mask substrate comprising the steps of:

providing the mask substrate; and

spraying aerosol onto the mask substrate for detaching particles from the mask substrate.

An apparatus for cleaning a mask substrate is known from the publication in Journal of Vacuum Science and Technology B, Vol. 20, No. 1, January/February 2002, p. 71-75, entitled: “Stencil reticle cleaning using an Ar aerosol cleaning technique”. The known apparatus comprises a process chamber comprising a purge gas inlet, an x-y scan stage for carrying the reticle, an aerosol nozzle, an accelerator nozzle and a gas outlet, which is connected to a dry pump.

The problem with the known apparatus is that detached particles having a very small size may fall back onto the reticle. This particle redeposition limits the cleaning efficiency of this apparatus. While scaling down feature sizes, this problem becomes even more apparent as the dust particle size of interest scales down as well and it is more difficult to detach smaller particles with relatively large aerosol particles.

It is an object of the invention to provide an apparatus, which is capable of cleaning mask substrates with a lower particle redeposition and thus a higher cleaning efficiency.

According to the invention, this object is achieved in that the apparatus for cleaning a mask substrate comprises a trap, which is located in the immediate vicinity of the aerosol nozzle and the support means, for trapping particles after the particles have been detached from the mask substrate. The advantage of adding the trap is that the chance of particle redeposition is reduced, which increases the mask cleaning efficiency.

In an embodiment according to the invention, the apparatus is characterized in that the trap comprises a cold trap. The main advantage of this type of trap is that thermophoretic forces are used to trap the particles. The lower the temperature of the trap, with respect to the mask substrate, the stronger the thermophoretic forces acting on particles between the trap and the mask substrate. The thermophoretic forces are directed towards the cold trap and increase the flow of particles to the cold trap.

In an embodiment according to the invention, the apparatus is characterized in that the cold trap is arranged for heating the mask substrate in a sub-step of the cleaning process and for trapping particles in another sub-step of the cleaning process. Heating the mask substrate has the advantage that the temperature gradient between the mask substrate and its environment is increased and thus also the thermophoretic forces towards the environment are increased. This helps reduce the flow of detached particles towards the mask substrate.

In an embodiment according to the invention, the trap comprises a vacuum trap. The main advantage is that detached particles are removed from the vicinity of the mask substrate, so that the chance that these particles fall back onto the mask substrate is reduced, which increases the mask cleaning efficiency.

In an embodiment according to the invention, the vacuum trap comprises a vacuum gap for trapping the detached particles. This has the advantage that the vacuum can be brought very close to the mask substrate, which enhances the trapping of detached particles.

In an embodiment according to the invention, the apparatus further comprises a carrier gas nozzle located in the vicinity of the aerosol nozzle for generating a carrier gas flow towards the vacuum gap. This feature has the advantage that the trapping of detached particles is enhanced.

In an embodiment according to the invention, the trap comprises an electrostatic trap. This has the advantage that particles which have an electrostatic charge are captured by the trap, which further decreases particle redeposition and increases the cleaning efficiency.

In an embodiment according to the invention, the electrostatic trap comprises parts having an electrical charge of a sign which, for attracting detached particles, is opposite to the sign of an electrical charge of said detached particles. The main advantage is that the electrostatic force can be regulated with a voltage source.

In an embodiment according to the invention, the electrostatic trap comprises both positively and negatively charged parts. The main advantage is that both positively and negatively charged particles are trapped.

In an embodiment according to the invention, the trap comprises a getter trap. The getter trap uses gettering to attract organic particles from its environment. Thus, these particles can be trapped on the getter plate. The advantage of adding the getter trap is that the chance of organic particle redeposition is reduced, which increases the mask cleaning efficiency.

In an embodiment according to the invention, the getter trap comprises a getter plate. The getter effect is improved by making a getter plate and put it close to the mask substrate.

In an embodiment according to the invention, the getter plate comprises Aluminum (Al). Aluminum is one of the materials known to have a high tendency to absorb organic molecules.

In an embodiment according to the invention, the apparatus comprises a heater for heating the mask substrate. Heating the mask substrate has the advantage that the temperature gradient between the mask substrate and its environment is increased and, thus, also the thermophoretic forces towards the environment are increased. Another advantage of using a heater is that it is no longer required (but still possible) that the cold trap is arranged for heating the mask substrate.

In an embodiment according to the invention, the apparatus further comprises a channel for releasing gas in order to transfer heat to the mask substrate. The main advantage of this measure is that the heat transfer from the heater to the mask substrate is significantly improved due to the high heat conductivity of gas (e.g. He) compared to air.

In an embodiment according to the invention, the apparatus further comprises transport means for moving the support means from the heater to the trap. This embodiment has the advantage that in a first sub-step the mask substrate can be brought near the heater, where after, in a second sub-step, the mask substrate can be brought near the trap. As a result, the heater and the trap can co-exist in this embodiment.

In an embodiment according to the invention, the apparatus is further characterized in that a distance between the heater and the trap, measured in a transport direction, is smaller than a dimension, measured in the same direction, of the mask substrate. In this embodiment, the mask substrate can be put near the heater as well as near the trap at the same time. A consequence of this is that the mask substrate can be transported gradually from the heater to the trap. In a certain phase of the cleaning process, a part of the mask substrate is heated, while another part is being exposed to the aerosol and the trap. This increases the cleaning efficiency.

In an embodiment according to the invention, the heater further comprises a channel for hot matter. This has the advantage that the heater can be heated very fast.

A method for cleaning a mask substrate according to the invention comprises the steps of:

providing the mask substrate;

spraying aerosol onto the mask substrate for detaching particles from the mask substrate; and

trapping particles immediately after the particles have been detached.

In an embodiment according to the invention, the method is characterized in that the detached particles are trapped with a cold trap.

In an embodiment according to the invention, the method is characterized in that the detached particles are trapped with a vacuum trap.

In an embodiment according to the invention, the method is characterized in that the detached particles are trapped with an electrostatic trap.

In an embodiment according to the invention, the method is characterized in that the detached particles are trapped with a getter trap.

In an embodiment according to the invention, the method is characterized in that, before spraying the aerosol, the mask substrate is heated.

These and other aspects of the apparatus for cleaning a mask substrate according to the invention will be further elucidated and described with reference to the drawings, in which:

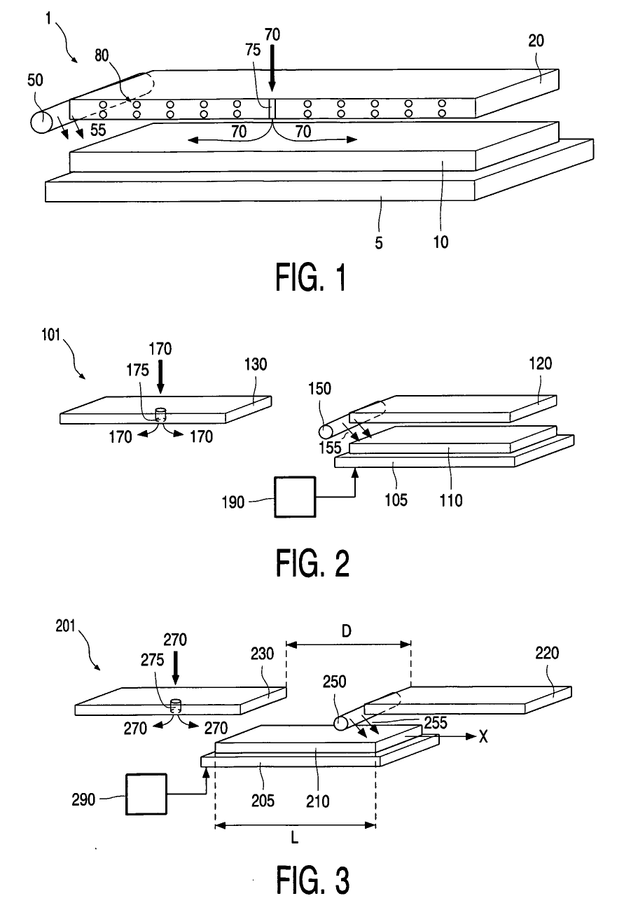

FIG. 1 illustrates a first embodiment according to the invention;

FIG. 2 illustrates a second embodiment according to the invention;

FIG. 3 illustrates a third embodiment according to the invention;

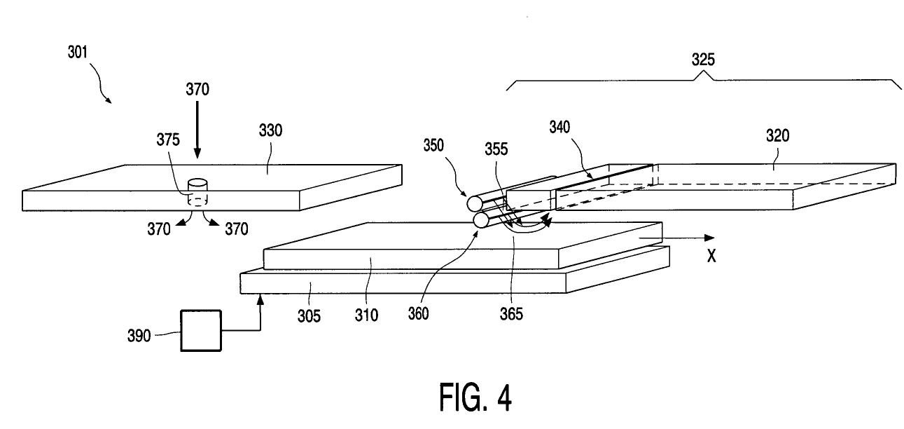

FIG. 4 illustrates a fourth embodiment according to the invention;

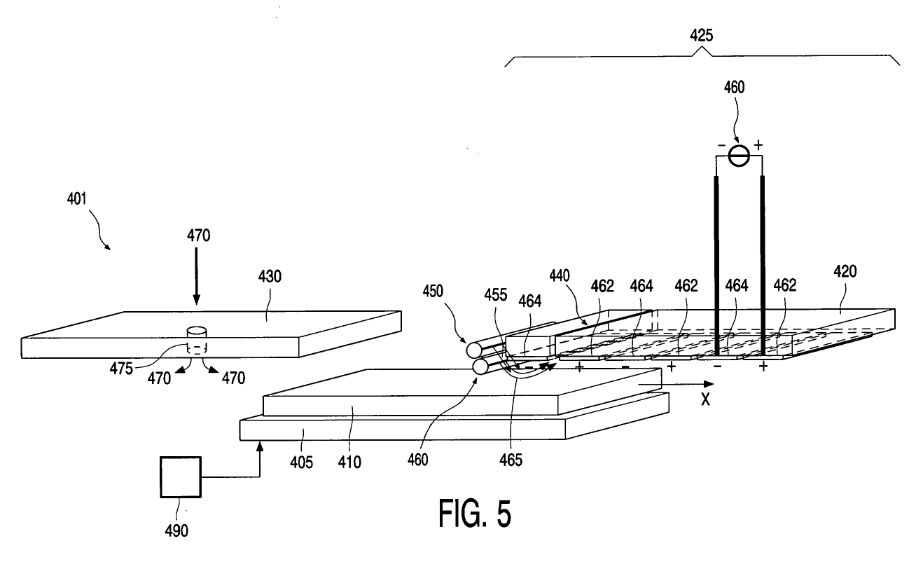

FIG. 5 illustrates a fifth embodiment according to the invention;

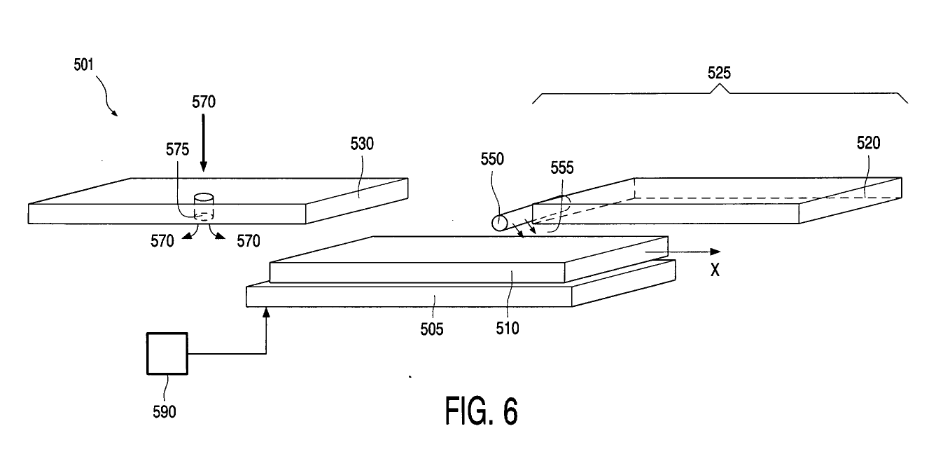

FIG. 6 illustrates a sixth embodiment according to the invention.

The present invention is described in detail later on, with reference to the appended drawings. However, it will be apparent that a person skilled in the art can imagine several other equivalent embodiments or other ways of executing the present invention, the spirit and scope of the present invention being limited only by the terms of the appended claims. All drawings are intended to illustrate some aspects and embodiments of the present invention. Most aspects are presented in a simplified way for reason of clarity. Not all alternatives and options are shown and therefore the invention is not limited to the content of the given drawings.

Before elaborating on the Figures, it is important to define what is meant by a trap. In general terms, a trap is a means for catching detached particles immediately after they have been detached to prevent them from falling back onto the mask substrate. From the Figures it will become clear that different types of traps can be used.

FIG. 1 shows an embodiment according to the invention, with a trap comprising a cold trap 20, which is also capable of heating a mask substrate 10. The cold trap 20 preferably comprises a plate, but other shapes are also possible. The mask cleaning apparatus 1 further comprises support means 5 for the mask substrate 10. The mask substrate 10 can be a finished mask, but also a mask which is in an intermediate stage of its manufacture. The support means 5 holds the mask substrate 10 to its place, for example by means of a vacuum (not shown in the Figures for simplicity). Close to the mask substrate 10 there is a cold trap 20. The cold trap 20 comprises means 80 for both heating and cooling the cold trap 20. These means 80 may be channels for hot and cold liquid or gas, electric channels for heating, radiation heaters or a combination of these. The mask cleaning apparatus 1 further comprises an aerosol nozzle 50 for blowing aerosol 55 towards the mask substrate 10. The use of aerosol 55 for removing particles is common knowledge to persons skilled in the art. In the Figure, the aerosol nozzle 50 is located on the left side, but in practice it can be located at any location. A possible embodiment of an aerosol nozzle 50 is a cylinder with small holes, through which the aerosol 55 is released.

In another embodiment according to the invention, the aerosol nozzle 50 can be moved such that it can “wipe” the particles from one side of the mask substrate 10 to the other side.

In a first stage of the mask cleaning process, the cold trap 20 is heated, which will lead to an increase of the temperature of the mask substrate 10. Heating the mask substrate 10 in this way is especially beneficial because of the fact that the mask substrate 10 is often made of quartz, which is a thermal insulator. It would therefore be very difficult and time consuming to heat the mask substrate 10 by heating the support means 5. Heat transfer from the cold trap 20 towards the mask substrate 10 is further improved by providing a channel 75, in or near the cold trap 20, through which gas 70 is blown towards the mask substrate 10. As a result, the gas 70 transfers heat from the cold trap 20 towards the mask substrate 10. The gas 70 could for example be Helium (He), but also other gases are suitable. Preferably, the gas 70 used has a higher heat conductivity than air.

In a second stage of the mask cleaning process, the gas flow 70 is stopped, and the cold trap 20 is cooled. This can be done with liquefied gases, like liquefied Helium (He) or liquefied Nitrogen (N₂).

In a third stage of the mask cleaning process, the aerosol nozzle 50 blows aerosol 55 towards the mask substrate 10, thereby causing particles to become detached from the mask substrate 10. Redeposition of the detached particles is reduced by the fact that the mask substrate 10 still has a comparatively high temperature with respect to its environment. The temperature gradient results in so-called thermophoretic forces on the particles, directed away from the mask substrate 10. The cold trap 20 has a substantively lower temperature than its environment, which results in thermophoretic forces on the particles, directed from the mask substrate 10 towards the cold trap 20, which results in a thermophoretic flow towards the cold trap 20. As a result, the detached particles are trapped on the cold trap 20 and the chance that particles fall back onto the mask substrate 10 is reduced.

FIG. 2 shows an embodiment according to the invention, with a trap comprising a cold trap 120. An additional heater 130 performs the heating function. The heater 130 preferably comprises a plate, but other shapes are also possible. The mask cleaning apparatus 101 further comprises a support means 105 and an aerosol nozzle 150 for blowing aerosol 155 towards the mask substrate 110.

In a first stage of the mask cleaning process, the mask substrate 110 is close to the heater 130, and the mask substrate 110 is heated. The heat transfer from the heater 130 towards the mask substrate 110 is further improved by providing a channel 175, in or near the heater 130, through which gas 170 is blown towards the mask substrate 110. As a result, the gas 170 transfers heat from the heater 130 towards the mask substrate 110. The gas 170 could for example be Helium (He), but also other gases are suitable.

In a second stage of the mask cleaning process, the gas flow 170 is stopped, and the mask 110 is transported close to the cold trap 120. The apparatus 101 comprises transport means 190 for enabling this transportation. The cold trap 120 is cooled.

In a third stage of the mask cleaning process, the aerosol nozzle 150 blows aerosol 155 towards the mask substrate 110, thereby causing particles to become detached from the mask substrate 110. Reducing the redeposition of detached particles is done in a similar way as in the situation in FIG. 1. Once detached, the particles are attracted by the cold trap 120 by means of thermophoretic forces, similarly to the situation shown in FIG. 1. As a result, the detached particles are trapped on the cold trap 120 and the chance that particles fall back onto the mask substrate 110 is reduced.

FIG. 3 shows an embodiment according to the invention, with a trap comprising a cold trap 220. An additional heater 230 performs the heating function. The heater 230 preferably comprises a plate, but other shapes are also possible. The mask cleaning apparatus 201 further comprises a support means 205 and an aerosol nozzle 250 for blowing aerosol 255 towards the mask substrate 210. The apparatus 201 is further characterized in that a distance D between the heater 230 and the cold trap 220, measured in a transport direction X, is smaller than a dimension L, measured in same direction X, of the mask substrate 210.

In a first stage of the mask cleaning process, the cold trap 220 is close to the heater 230, and the mask substrate 210 is heated. The heat transfer from the heater 230 towards the mask substrate 210 is further improved by providing a channel 275, in or near the heater 230, through which gas 270 is blown towards the mask substrate 210. As a result, the gas 275 transfers heat from the heater 230 towards the mask substrate 210. The gas 270 could for example be Helium (He), but also other gases are suitable.

In a second stage of the mask cleaning process, the gas flow 270 is stopped, and the mask 210 is gradually transported to the cold trap 220. The apparatus 201 comprises transport means 290 for enabling this gradual transportation. Preferably, the cold trap 220 is cooled and the heater 230 is heated during this transportation. In this stage of the cleaning process, the aerosol nozzle 250 blows aerosol 255 towards the mask substrate 210, thereby causing particles to become detached from the mask substrate 210. Reducing the redeposition of detached particles is done in a similar way as in the situation in FIG. 1. Once detached, the particles are attracted by the cold trap 220 by means of thermophoretic forces, similarly to the situation shown in FIG. 1. As a result, the detached particles are trapped on the cold trap 220 and the chance that particles fall back onto the mask substrate 210 is reduced.

FIG. 4 shows an embodiment according to the invention, with a trap comprising a vacuum trap 325. The mask cleaning apparatus 301 further comprises a support means 305, transport means 390, and an aerosol nozzle 350 for blowing aerosol 355 towards the mask substrate 310. Similarly to the previous Figures, the apparatus 301 further comprises a channel 375, in or near the heater 330, through which gas 370 is blown towards the mask substrate 310.

The vacuum trap 325 comprises a vacuum gap 340 in a plate 320. In the vacuum gap 340 there is a lower pressure than near the mask substrate 310. This lower pressure creates an airflow towards the gap, which traps detached particles. A lower pressure can be created by means of, for example, a vacuum pump (not shown in the Figure). Obviously, the above-mentioned vacuum pump is used for trapping particles in the vicinity of the mask substrate and not for lowering the pressure throughout the environment surrounding the mask substrate.

Detaching particles is done in a similar way as in the previous Figures, using an aerosol nozzle 350 for blowing aerosol 355. Preferably, reducing the redeposition of detached particles is done in a similar way as in the previous embodiments using an additional heater 330. The heater 330 preferably comprises a plate, but other shapes are also possible. Another improvement of the mask cleaning apparatus 301 is achieved by the addition of a carrier gas nozzle 360 for blowing a carrier gas 365 towards the vacuum gap 340.

FIG. 5 shows an embodiment according to the invention, with a trap comprising an electrostatic trap 425. The mask cleaning apparatus 401 further comprises a support means 405, transport means 490, and an aerosol nozzle 450 for blowing aerosol 455 towards the mask substrate 410. Similarly to the previous Figures, the apparatus 401 further comprises a channel 475, in or near the heater 430, through which gas 470 is blown towards the mask substrate 410.

The electrostatic trap 420 comprises charged elements 462, 464. In a preferred embodiment, both positively charged elements 462 and negatively charged elements 464 are used, which has the advantage that both positively and negatively charged particles are trapped. A further improvement is achieved by employing more than one charged element for each charge sign. Preferably, these elements are alternately placed, as illustrated in the Figure. In this embodiment, a plate 420 is used as the holding means for the charged elements 462, 464. In other embodiments, these holding means may not be required. For example a voltage source 460 can be used to charge the elements 462, 464. In this particular embodiment, the trap also comprises, similarly to FIG. 4, a vacuum trap comprising a vacuum gap 440 and a carrier gas nozzle 460. Detaching particles is done in a similar way as in the previous Figures, using an aerosol nozzle 450 for blowing aerosol 455 and preferably a carrier gas nozzle 460 for blowing a carrier gas 465 towards the vacuum gap 440.

FIG. 6 shows an embodiment according to the invention, with a trap comprising a getter trap 525. The mask cleaning apparatus 501 further comprises a support means 505, transport means 590, and an aerosol nozzle 550 for blowing aerosol 555 towards the mask substrate 510. Similarly to the previous Figures, the apparatus 501 further comprises a channel 575, in or near the heater 530, through which gas 570 is blown towards the mask substrate 510.

The getter trap 525 comprises a getter plate 520. Certain metals are known to have the property that, once oxidized, they attract organic (molecular) particles from air. This process is called gettering. Once the particles touch the getter plate 520 they cannot easily be detached from it, thus the getter plate works as a trap. The getter plate 520 is preferably put close to the mask substrate 510. The getter trap may also have other shapes besides the plate shape used here. In a preferred embodiment, the getter plate 520 comprises Aluminum, because Aluminum oxide has a high tendency to absorb organic molecules. Once in contact with e.g. air, the oxide layer is formed very quickly on a pure Aluminum surface. Other metals like e.g. Titanium (Ti) may also be used as a getter metal.

Detaching particles is done in a similar way as in the previous Figures, using an aerosol nozzle 550 for blowing aerosol 555. Preferably, redeposition of detached particles is reduced in a similar way as in the previous embodiments, using an additional heater 530. The heater 530 preferably comprises a plate, but other shapes are also possible.

Please note that the description is meant to support the claims rather than limit them. Many variations are possible to the illustrations shown. Four different kinds of traps have been illustrated, which may be used on their own. However, they can be combined as well. Besides the combination as described in FIG. 5, other combinations are possible, for example (non-exhaustive list):

a cold trap together with a vacuum trap;

a cold trap together with an electrostatic trap;

a cold trap together with a getter trap; or

a cold trap together with a getter trap, a vacuum trap and an electrostatic trap.

As already mentioned in the description, some parts of the mask cleaning apparatus are optional: the heater, the carrier gas nozzle, the channel through which gas is blown towards the mask substrate for improving heat transfer, etc. A person skilled in the art could also easily come up with methods for heating and cooling, which are different from those mentioned in this description. These and other variations do not depart from the scope of the appended claims.

1. An apparatus for cleaning a mask substrate comprising:
a support means for receiving a mask substrate; and
an aerosol nozzle for cleaning the mask substrate by detaching particles from the mask substrate;
characterized in that the apparatus comprises a trap, which is located in the immediate vicinity of the aerosol nozzle and of the support means for trapping particles after the particles have been detached from the mask substrate.

2. An apparatus as claimed in claim 1, characterized in that the trap comprises a cold trap.

3. An apparatus as claimed in claim 2, characterized in that the cold trap is arranged for heating the mask substrate in a sub-step of the cleaning process and for trapping particles in another sub-step of the cleaning process.

4. An apparatus as claimed in claim 1, characterized in that the trap comprises a vacuum trap.

5. An apparatus as claimed in claim 4, characterized in that the vacuum trap comprises a vacuum gap for trapping the detached particles.

6. An apparatus, as claimed in claim 4, characterized in that the apparatus comprises a carrier gas nozzle located in the vicinity of the aerosol nozzle for generating a carrier gas flow towards the vacuum gap.

7. An apparatus as claimed in claim 1, characterized in that the trap comprises an electrostatic trap.

8. An apparatus as claimed in claim 7, characterized in that the electrostatic trap comprises parts, having an electrical charge with a sign, for attracting detached particles having an electrical charge with an opposite sign.

9. An apparatus as claimed in claim 8, characterized in that the electrostatic trap comprises both positively and negatively charged parts for attracting both positively and negatively charged detached particles.

10. An apparatus as claimed in claim 1, characterized in that the trap comprises a getter trap.

11. An apparatus as claimed in claim 10, characterized in that the getter trap comprises a getter plate.

12. An apparatus as claimed in claim 10, characterized in that the getter plate comprises Aluminum (Al).

13. An apparatus as claimed in claim 1, characterized in that the apparatus comprises a heater for heating the mask substrate.

14. An apparatus as claimed in claim 3, characterized in that the apparatus comprises a channel for releasing gas in order to transfer heat to the mask substrate.

15. An apparatus as claimed in claim 13, characterized in that the apparatus comprises transport means for moving the support means from the heater to the trap.

16. An apparatus as claimed in claim 13, characterized in that a distance (D) between the heater and the trap, measured in a transport direction (X), is smaller than a dimension (L), measured in the same direction (X), of the mask substrate.

17. An apparatus as claimed in claim 13, characterized in that the heater comprises a channel for hot matter.

18. A method of cleaning a mask substrate comprising steps of:
providing the mask substrate; and
spraying aerosol on the mask substrate for detaching particles from the mask substrate;
characterized by trapping particles immediately after the particles have been detached from the mask substrate.

19. A method as claimed in claim 18, characterized in that the detached particles are trapped with a cold trap.

20. A method as claimed in claim 18, characterized in that the detached particles are trapped with a vacuum trap.

21. A method as claimed in claim 18, characterized in that the detached particles are trapped with an electrostatic trap.

22. A method as claimed in claim 18, characterized in that the detached particles are trapped with a getter trap.

23. A method as claimed in claim 18, characterized in that before spraying the aerosol, the mask substrate is heated.
